(19) United States
(12) Patent Application Publication
(10) Pub. No.: US 2013/0206303 A1
(43) Pub. Date: Aug. 15, 2013

(54) TIRE FOR TRUCK OR BUS

(71) Applicant: Sumitomo Rubber Industries, Ltd., (US)

(72) Inventor: Daisuke TODOROKI, Kobe-shi (JP)

(73) Assignee: SUMITOMO RUBBER INDUSTRIES, LTD., Kobe-shi (JP)

(21) Appl. No.: 13/751,323

(22) Filed: Jan. 28, 2013

(30) Foreign Application Priority Data
Feb. 15, 2012 (JP) 2012-030342

(51) Int. Cl. B60C 1/00

(52) U.S. Cl. 152/510

(57) ABSTRACT

A truck/bus tire has an internal surface covered with an air-seal layer that has an end in a region within 120 mm as measured from a toe tip of a bead portion along a bead base line and is configured of a stack of layers of polymers including a first layer of an elastomer composition containing a SIBS and having a thickness of 0.05-0.6 mm and a second layer of an elastomer composition containing at least one of a SIS and a SIB, having a thickness of 0.01-0.3 mm, and positioned adjacent to a carcass ply. The first and second layers have the elastomer compositions with a dynamic modulus of elasticity (E^{*}) of 2-5 MPa. A pneumatic tire can be provided that includes an air-seal layer having limited variation at an internal surface of the tire for enhanced air permeation resistance and increased rolling resistance.

This nonprovisional application is based on Japanese Patent Application No. 2012-30342 filed on Feb. 15, 2012, with the Japan Patent Office, the entire contents of which are hereby incorporated by reference.

### BACKGROUND OF THE INVENTION

1. Field of the Invention

The present invention relates to a tire provided for a truck or bus and including an air-seal layer.

2. Description of the Background Art

In recent years, there is a large social demand for fuel-efficient vehicles and hence lightweight tires, and, among tire members, an air-seal layer reducing air leakage from a pneumatic tire, i.e., having a function to have air permeation resistance, is also required to be lightweight.

Currently, a rubber composition for an air-seal layer allows a tire to have enhanced air permeation resistance by employing for example a rubber blend mainly of a butyl rubber containing 70-100% by mass of butyl rubber and 30-0% by mass of natural rubber. Furthermore, a rubber blend mainly of butyl rubber contains about 1% by mass of isoprene other than butylene, and this, in combination with sulfur, a vulcanization accelerator, and zinc white, allows intermolecular co-crosslinking with an adjacent rubber layer. When this butyl-based rubber is provided in a typical blend, a tire for a passenger car will require a thickness of about 0.6-1.0 mm and a tire for a truck or bus will require a thickness of about 1.0-2.0 mm, and, to reduce the tires in weight, there is a demand for a polymer having larger air permeation resistance than the butyl-based rubber and allowing an air-seal layer to be further reduced in thickness.

Japanese Patent Laying-Open No. 9-019987 discloses a stack of layers for enhanced adhesion between an air-seal layer and a rubber layer. The air-seal layer has opposite sides provided with adhesive layers so that the air-seal layer has portions overlapping each other with the adhesive layers in contact with each other and heated and thus firmly bonded together to better hold air pressure. However, the adhesive layer allowing the air-seal layer to have portions overlapping each other will be brought into contact with a bladder in a vulcanization step in a heated condition, and thus adhere to the bladder disadvantageously.

Japanese Patent Laying-Open No. 2000-159936 describes that satisfactory air permeable nylon resin and butyl rubber are dynamically crosslinked to provide a mixture to produce a 100-μm-thick air-seal layer. Nylon resin is, however, hard at the room temperature and thus unsuitable for an air-seal layer for tires. Furthermore, this dynamically crosslinked mixture alone does not adhere to a rubber layer through vulcanization, and accordingly, apart from the air-seal layer, a vulcanizing adhesion layer is required, resulting in an air-seal layer member structurally complicated and involving a large number of process steps, which is disadvantageous in terms of productivity.

Japanese Patent Laying-Open No. 2008-024219 describes dispersing a maleic anhydride denatured, hydrogenated styrene-ethylene-butadiene-styrene block copolymer in a satisfactorily air-sealing ethylene-vinyl alcohol copolymer to produce a soft gas barrier layer. Furthermore the gas barrier layer is sandwiched by a thermoplastic polyurethane layer, and furthermore, a rubber glue (70/30 of butyl rubber/natural rubber dissolved in toluene) is applied on a surface adjacent to tire rubber to produce an air-seal layer.

However, a soft resin dispersed, denatured ethylene-vinyl alcohol copolymer has poor adhesive strength and may peel off the thermoplastic polyurethane layer. Furthermore, although the soft resin dispersed, denatured ethylene-vinyl alcohol copolymer has a soft resin dispersed therein, its matrix of EVOH is poor in flexural fatigue strength and it will be destroyed while the tire travels. Furthermore, applying the rubber glue to the surface to be bonded to tire rubber requires another process other than that for normally producing an air-seal layer and hence will result in inferior productivity.

Japanese Patent Laying-Open No. 2009-173114 relates to a tire provided for heavy load and having an air-seal layer in an inner side of an inner liner or in place of the inner liner that has a predetermined thickness including a layer formed of a resin composition of a particular oxygen permeability having a matrix of a denatured ethylene-vinyl alcohol copolymer with a soft resin having a smaller Young's modulus than the copolymer dispersed therein, at least adjacent to a toe tip of a bead portion of a tire to allow the tire to better hold air and have the bead portion enhanced in durability. This technique, however, provides insufficient adhesion between the air-seal layer and carcass rubber and may not provide sufficient flexural fatigue strength.

### SUMMARY OF INVENTION

The present invention contemplates a tire provided for a truck or bus and including an air-seal layer having limited variation at an internal surface of the tire for enhanced air permeation resistance and increased rolling resistance.

The present invention provides a tire provided for a truck or bus and having an internal surface covered with an air-seal layer. The air-seal layer has an end in a region within 120 mm as measured from a toe tip of a bead portion along a bead base line and is configured of a stack of layers of polymers including a first layer of an elastomer composition containing a styrene-isobutylene-styrene triblock copolymer and having a thickness of 0.05 mm to 0.6 mm and a second layer of an elastomer composition containing at least one of a styrene-isoprene-styrene triblock copolymer and a styrene-isobutylene diblock copolymer, having a thickness of 0.01 mm to 0.3 mm, and positioned adjacent to a carcass ply. The first and second layers have the elastomer compositions with a dynamic modulus of elasticity (E^{*}) having a value equal to or larger than 2 MPa and equal to or smaller than 5 MPa.

The stack of layers of polymers has a first thickness (T0) when formed on a drum in forming the tire, whereas the stack of layers of polymers has a second thickness (T1) when extended in a toroid, with a ratio of the second thickness (T1) to the first thickness (T0) (T1/T0×100) being 50-75% between a buttress portion of the tire and an equatorial plane of the tire.

Preferably, the styrene-isobutylene-styrene triblock copolymer contains styrene units in a content of 10-30% by mass. Furthermore, preferably, the styrene-isoprene-styrene triblock copolymer contains styrene units in a content of 10-30% by mass and has a weight average molecular weight of 100,000 to 290,000, and furthermore, the styrene-isobutylene diblock copolymer is of a straight chain, contains styrene units in a content of 10-35% by mass, and has a weight average molecular weight of 40,000-120,000.

The present truck or bus tire has the stack of layers of polymers used for an air-seal layer and also has its range in dynamic modulus of elasticity (E^{*}) adjusted. Thus when it is extended from a tire forming condition on a drum to be toroidal, it can be uniform in thickness and also reduced in thickness, and can also seal air in an internal cavity of the tire externally to maintain internal pressure therein, and furthermore, can provide enhanced adhesion to an adjacent rubber layer. A tire having excellent air sealability and increased rolling resistance for a truck or bus can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross section of a right half of a tire for a truck or bus in one embodiment of the present invention.

FIG. 2 is an enlarged cross section of a bead portion of a tire for a truck or bus in one embodiment of the present invention.

FIG. 3A shows a stack of layers of polymers drum-formed.

FIG. 3B is a schematic view of the stack shaped in a toroid.

FIG. 4 is a schematic cross section of an air-seal layer in one embodiment of the present invention.

### DESCRIPTION OF THE PREFERRED EMBODIMENTS

The present invention is a pneumatic tire having an internal surface provided with an air-seal layer formed of a stack of at least two layers of polymers. A first layer is formed of a styrene-isobutylene-styrene triblock copolymer (SIBS) and has a thickness in a range of 0.05 mm to 0.6 mm. A second layer includes at least one of a styrene-isoprene-styrene triblock copolymer (SIS) and a styrene-isobutylene diblock copolymer (SIB) and has a thickness of 0.01 mm to 0.3 mm. The second layer is disposed in contact with a rubber layer of a carcass ply.

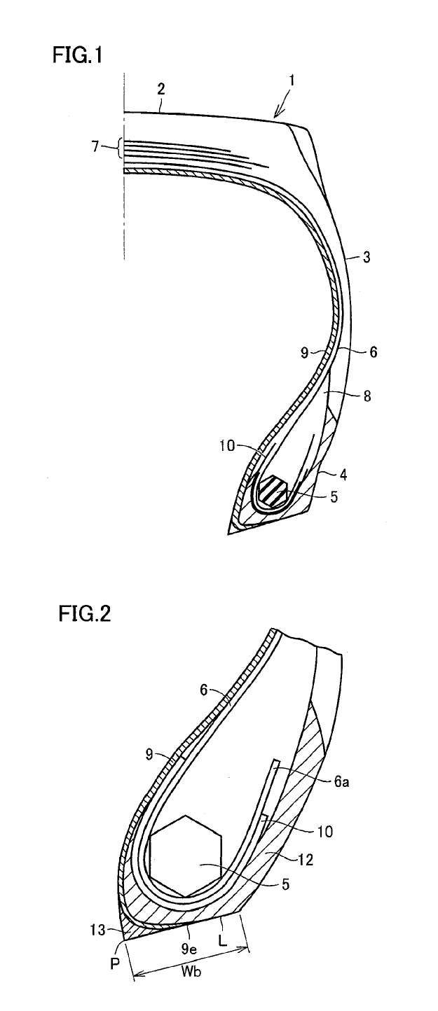

The present tire for a truck or bus will be described with reference to schematic cross sections. FIG. 1 is a cross section of a right half of the tire for a truck or bus, and FIG. 2 shows a bead portion thereof in an enlarged view. A tire 1 for a truck or bus has a tread portion 2, and a sidewall portion 3 and a bead portion 4 forming a toroid from the opposite ends of the tread portion. Furthermore, bead portion 4 has a bead core 5 buried therein. Furthermore, there are provided a carcass ply 6 extending from one bead portion 4 to the other bead portion and having opposite ends folded back around bead core 5 and thus engaged, and a belt layer 7 formed of four plies outer than a crown portion of carcass ply 6.

Belt layer 7 normally has four plies formed of steel cord or aramid fiber cord or similar cord and intersecting with each other to have the cord to normally form an angle of 5-30 degrees relative to the tire's circumferential direction or having a portion disposed in a single direction. Note that a topping rubber layer can be provided outer than the opposite ends of the belt layer to prevent the belt layer from having the opposite ends peeled off. Furthermore, the carcass ply generally has steel cord disposed substantially at 90 degrees relative to the tire's circumferential direction, and in a region surrounded by the carcass ply and a portion thereof folded back a bead apex 8 is provided extending from an upper end of bead core 5 toward the sidewall. Furthermore, inside carcass ply 6, as seen in the tire's radial direction, an air-seal layer 9 is disposed extending from one bead portion 4 to the other bead portion 4.

Furthermore, in a portion with carcass ply 6 folded back around bead core 5, a bead reinforcement layer 10 formed of steel cord, aramid fiber code, or nylon fiber code is disposed.

Note that the tire for a truck or bus of the present invention may not be provided with an inner liner, as shown in the figure, and in that ease, the tire will have an internal surface covered with air-seal layer 9 directly disposed inside carcass ply 6 as seen in the tire's radial direction.

In FIG. 1 and FIG. 2, air-seal layer 9 covers an internal surface of the tire and is folded at a toe tip P back in the direction of the width of the tire, and also has a lower end 9e positioned in a region of a bead baseline width Wb from toe tip P along a bead baseline L. Herein, bead baseline width Wb will normally have a range of 100 to 120 mm for a tire for a truck or bus. If air-seal layer 9 is disposed from toe tip P along bead baseline L to a region exceeding 120 mm, air-seal layer 9 reaches a portion which contacts a rim and the rim may poorly be attached.

When a tire travels, a bead portion repeatedly deforms, resulting in air externally introduced between the bead portion and a bead base portion into the tire. Air-seal layer 9 can reduce such air introduced into the tire and thus maintain internal pressure. Furthermore, as the oxygen externally introduced into the tire is reduced, the air-seal layer's degradation can be reduced and the bead portion's durability can significantly be enhanced.

Note that a rubber chafer 12 is disposed at a bead region directly in contact with the bead base and a rim flange to reinforce the bead portion. Furthermore, the toe portion is provided with toe rubber 13 covering lower end portion 9e of the air-seal layer. Toe rubber 13 is such a rubber composition that 20-40% by mass of a rubber component is formed of at least one of butyl rubber and halogenated butyl rubber.

<Air-Seal Layer>

In the present invention the air-seal layer is formed of a stack of layers of particular polymers. The stack of layers of polymers is formed of a first layer containing a styrene-isobutylene-styrene triblock copolymer (SIBS) and having a thickness in a range of 0.05 mm to 0.6 mm and a second layer containing at least one of a styrene-isoprene-styrene triblock copolymer (SIS) and a styrene-isobutylene diblock copolymer (SIB) and having a thickness of 0.01 mm to 0.3 mm.

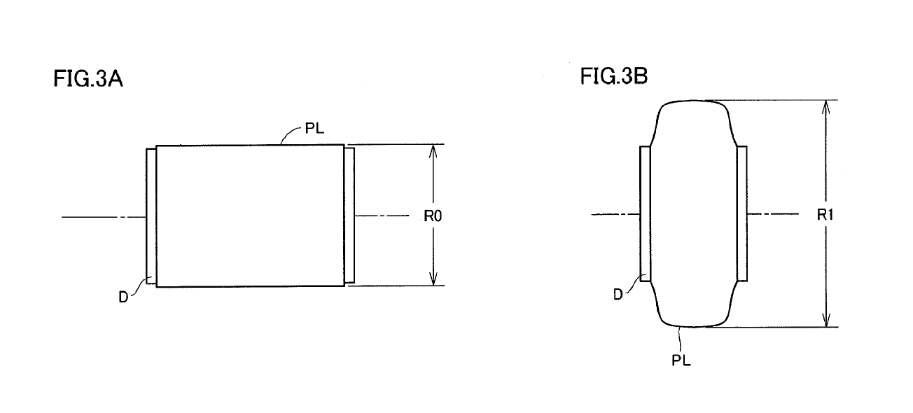

In forming a tire, the stack of layers of polymers is put on a drum together with a carcass ply and other members of the tire, as shown in FIG. 3A, and then extended in a toroid, as shown in FIG. 3B. In doing so, the stack of layers of polymers is extended from a cylindrical form having a diameter RO to a toroidal form having a maximum diameter R1. Herein, R1 is extended to 140% to 200% of R0. As a result, the stack of layers of polymers has its thickness on the drum (T0) reduced to a thickness in the form of the toroid (T1) with a ratio (T0/T1×100) of 50% to 70%. In doing so, if the stack of layers of polymers does not have the first and second layers extended at a uniform rate, it will vary in thickness, and not only is it unable to seal air but may also be torn.

To overcome this disadvantage, the present invention provides the first and second layers with a dynamic modulus of elasticity (E^{*}) having a value adjusted to fall within a range of 2 MPa to 5 MPa. A dynamic modulus of elasticity (E^{*}) smaller than 2 MPa allows the stack of layers of polymers to flow in vulcanizing the tire and as a result the stack of layers of polymers does not remain in the tire as a product and thus cannot seal air. In contrast, A dynamic modulus of elasticity (E^{*}) exceeding 5 MPa results in a tire formed with a stack of layers of polymers of poor extensibility, which makes it difficult to adjust the air-seal layer in thickness in the tire as a product. Note that a dynamic modulus of elasticity (E^{*}) is measured with a viscoelasticity spectrometer VES (produced by IWAMOTO Quartz Glass Lab Co., Ltd.) at 70° C. with an initial strain of 10% and a dynamic strain of 2%.

<First Layer>

The present invention provides an air-seal layer formed with a stack of layers of polymers that are a first layer disposed inside a tire and a second layer disposed closer to a carcass ply. The first layer is a SIBS layer having a polymer composition containing a styrene-isobutylene-styrene triblock copolymer (SIBS) by an amount equal to or larger than 50% by mass of a polymer component.

Preferably, the SIBS contains styrene units in a content of 10 to 30% by mass, preferably 14 to 23% by mass, for adjusting the dynamic modulus of elasticity to fall within a specific range and obtaining enhanced air permeation resistance.

Furthermore, the SIBS preferably has a molecular weight with a weight average molecular weight of 50,000 to 400,000 through GPC measurement in view of adjusting the dynamic modulus of elasticity and furthermore, in view of flowability, a shaping process, and the like. A weight average molecular weight less than 50,000 may result in reduced tensile strength and reduced tensile elongation, whereas a weight average molecular weight exceeding 400,000 may result in impaired extrudability unpreferably.

As the SIBS has an isobutylene block therein, the SIBS can be used to produce a polymer film having excellent air permeation resistance. When the polymer film of the SIBS is used to produce the air-seal layer, a pneumatic tire having excellent air permeation resistance can be obtained.

Furthermore, the SIBS does not have double bonds in its molecule other than the aromatic group, and is thus significantly stable against ultraviolet rays and thus has excellent durability. When the polymer film of the SIBS is used to produce the air-seal layer, a pneumatic tire having excellent durability can be obtained.

Applying the polymer film of the SIBS to the air-seal layer to produce a pneumatic tire ensures air permeation resistance. This can eliminate the necessity of using halogenated butyl rubber or a similar halogenated rubber of a large specific gravity conventionally used to provide air permeation resistance, and if it is used it can be used in a reduced amount. A tire reduced in weight can be obtained and better fuel economy can effectively be achieved.

Preferably, the SIBS, in its copolymer, has its blocks with degrees of polymerization of about 10,000-150,000 for isobutylene and about 5,000-30,000 for styrene in view of rubber elasticity and handlability (as a degree of polymerization less than 10,000 provides liquefacation).

The first layer of the SIBS has a thickness of 0.05 to 0.6 mm. If the first layer has a thickness less than 0.05 mm, then, in vulcanizing green tire with the stack of layers of polymers applied thereto as the air-seal layer, the first layer will be torn as it is pressed, and the obtained tire may have air leaked therefrom. In contrast, if the first layer has a thickness exceeding 0.6 mm, the tire will be increased in weight resulting in impaired low-fuel-consumption performance. The first layer can be formed into film by extruding or calendering the SIBS or a similar method normally employed to form thermoplastic resin, thermoplastic elastomer or the like into film.

<Second Layer>

In the present invention the second layer includes at least one of an SIS layer formed of a styrene-isoprene-styrene triblock copolymer (SIS) and an SIB layer formed of a styrene-isobutylene diblock copolymer (SIB).

The styrene-isoprene-styrene triblock copolymer (SIS) has an isoprene block, which is a soft segment, and accordingly, a polymer film formed of the SIS easily adheres to a rubber component through vulcanization. If the polymer film formed of the SIS is used for the air-seal layer, which is excellent in adhering for example to a rubber layer of the carcass ply, a pneumatic tire excellent in durability can be obtained.

Preferably the SIS has a molecular weight with a weight average molecular weight of 100,000 to 290,000 through GPC measurement in view of adjusting the dynamic modulus of elasticity to fall within a particular range, and formability. A weight average molecular weight less than 100,000 may result in reduced tensile strength, whereas a weight average molecular weight exceeding 290,000 results in poor extrudability unpreferably. Furthermore, preferably, the SIS contains styrene units in a content of 10-30% by mass to adjust the dynamic modulus of elasticity to fall within the aforementioned range.

Furthermore, preferably, the SIS has its blocks with degrees of polymerization of about 500-5,000 for isoprene and about 50-1,500 for styrene in view of adjusting the dynamic modulus of elasticity to fall within a particular range.

The SIS can be obtained by a typical method for polymerization of a vinyl based compound, such as living cationic polymerization. The SIS layer can be formed into film by extruding or calendering the SIS or a similar method normally employed to form thermoplastic resin, thermoplastic elastomer or the like into film.

The styrene-isobutylene diblock copolymer (SIB) has an isobutylene block, which is a soft segment, and accordingly, a polymer film formed of the SIB easily adheres to a rubber component through vulcanization. If the polymer film formed of SIB is used for the air-seal layer, which is excellent in adhering for example to the carcass ply, adjacent rubber that forms insulation, and the like, a pneumatic tire excellent in durability can be obtained.

Preferably, the SIB is of straight chain in view of rubber elasticity and adhesiveness. Preferably the SIB has a molecular weight with a weight average molecular weight of 40,000 to 120,000 through GPC measurement in order to adjust the dynamic modulus of elasticity to fall within a particular range and obtain better formability. A weight average molecular weight less than 40,000 may result in reduced tensile strength, whereas a weight average molecular weight exceeding 120,000 may result in impaired extrudability unpreferably.

Furthermore, preferably, the SIB contains styrene units in a content of 10-35% by mass to adjust the dynamic modulus of elasticity to fall within the aforementioned range and obtain better viscosity and better adhesiveness.

In the present invention, preferably, the SIB has its blocks with degrees of polymerization of about 300-3,000 for isobutylene and about 10-1,500 for styrene in view of rubber elasticity and handlability.

The SIB layer can be formed into film by extruding or calendering the SIB or a similar method normally employed to form thermoplastic resin, thermoplastic elastomer or the like into film.

The second layer has a thickness of 0.01 mm to 0.3 mm. Herein, the thickness of the second layer means a total thickness of the SIS layer and the SIB layer if the second layer is formed of the two layers of the SIS layer and the SIB layer.

If the second layer has a thickness less than 0.1 mm, then, in vulcanizing green tire with the stack of layers of polymers applied thereto as the air-seal layer, the second layer will be torn as it is pressed, resulting in reduced adhesive strength through vulcanization. In contrast, if the second layer has a thickness exceeding 0.3 mm, the tire will be increased in weight resulting in impaired low-fuel-consumption performance. Furthermore, preferably, the second layer has a thickness of 0.05-0.2 mm.

<Forms of Stack of Layers of Polymers>

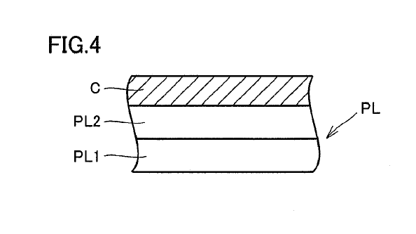

The present invention can provide an air-seal layer fanned with a stack of layers of polymers structured in a variety of forms. These forms will be described hereinafter with reference to FIG. 4 showing an air-seal layer schematically in cross section. A stack of layers of polymers PL is configured of a first layer PL1 and a second layer PL2, as shown in FIG. 4. If the stack of layers of polymers PL is applied to a pneumatic tire as the air-seal layer, placing second layer PL2 at an outer position, as seen in the tire's radial direction, in contact with a carcass ply C, allows a subsequent tire vulcanization step to be performed to provide increased adhesive strength between second layer PL2 and carcass ply C. Accordingly, the obtained pneumatic tire has the air-seal layer and an inner liner or a rubber layer of carcass ply C satisfactorily adhering to each other, and can thus have enhanced air permeation resistance and excellent durability.

<Method for Producing Tire for Truck or Bus>

The present invention provides a truck or bus tire, which can be produced in a general method. The present tire can be produced by applying the stack of layers of polymers PL to an air-seal layer of a green tire for tire 1 for a truck or bus and vulcanizing and thus shaping it together with other members. The stack of layers of polymers PL is disposed on the green tire such that the stack of layers of polymers PL has second layer PL2 to face outward, as seen in the tire's radial direction, in contact with the carcass ply (or the inner liner if it is used).

This arrangement allows a subsequent tire vulcanization step to be performed to provide increased adhesive strength between second layer PL2 and carcass ply C (or the inner liner). The obtained pneumatic tire has the air-seal layer and the carcass ply satisfactorily adhering to each other, and can thus have enhanced air permeation resistance and excellent durability.

### EXAMPLES

A specification shown in Table 1 was employed to produce tires of examples of the present invention and those of comparative examples for a truck or bus, and the tires were assessed in performance. The SIB, SIBS, and SIS used for the first and second layers were prepared as follows:

<SIBS>

SIBSTAR 102T produced by Kaneka Corporation (Shore A hardness: 25, styrene content: 15% by mass, weight average molecular weight: 100,000) was used. Other SIBSs having different styrene contents were in conformity with a polymerization method described in Japanese Patent Laying-Open No. 2002-161186, and were produced with a monomer ratio changed in a copolymerization reaction of isobutylene and styrene.

<SIB>

589 mL of methylcyclohexane (dried by molecular sieves), 613 ml of n-butyl chloride (dried by molecular sieves), and 0.550 g of cumyl chloride were introduced into an agitator equipped, 2 L reactor. The reactor was cooled to −70° C., and thereafter 0.35 mL of α-picoline (2-methylpyridine) and 179 mL of isobutylene were added. Furthermore, 9.4 mL of titanium tetrachloride was added and polymerization was started, and the solution was agitated at −70° C. and thus reacted for 2.0 hours. Then, 59 mL of styrene was introduced into the reactor and the reaction was further continued for 60 minutes, and thereafter a large amount of methanol was added and the reaction was stopped. The reactional solution had a solvent or the like removed therefrom and thereafter a polymer was dissolved in toluene and washed with water twice. This toluene solution was added to the methanol mixture and the polymer was precipitated, and the obtained polymer was dried at 60° C. for 24 hours to obtain a styrene-isobutylene diblock copolymer.

Styrene as component in content of: 15% by mass

Weight average molecular weight: 70,000

Note that SIBs having different styrene contents were in conformity with the aforementioned polymerization method and produced with a monomer ratio changed in a copolymerization reaction of isobutylene and styrene.

<SIS>

D1161JP produced by Kraton Performance Polymers Inc. (styrene as component in content of: 15% by mass, and weight average molecular weight: 150,000) was used. Note that SISs having different styrene contents were produced with a monomer ratio changed in a copolymerization reaction of isoprene and styrene.

<Producing Tire for Truck or Bus>

The above SIBS, SIS, and SIB were pelletized with a biaxial extruder (screw diameter: φ50 mm, L/D: 30, cylinder temperature: 220° C.). Thereafter, a T die extruder (screw diameter: φ80 mm, L/D: 50, die lip width: 500 mm, cylinder temperature: 220° C., film gauge: 0.3 mm) or a multi-layer blown film machine was used to produce an air-seal layer.

For a tire for a truck or bus of a 11R22.5 14PR size having the FIG. 1 basic structure and the FIG. 2 bead portion structure, the stack of layers of polymers was used for the air-seal layer to produce green tire and a vulcanization step was then performed to press-mold the intermediate product at 150° C. for 35 minutes to produce a vulcanized tire.

TABLE 1

| | | | | comp. | comp. | | | comp. | comp. | | | comp. |
|---|---|---|---|---|---|---|---|---|---|---|---|---|
| | | | ex. 1 | ex. 1 | ex. 2 | ex. 2 | ex. 3 | ex. 3 | ex. 4 | ex. 4 | ex. 5 | ex. 5 |
| Air-seal | 1st | Thickness of SIBS layer (mm) | 0.3 | — | 0.3 | 0.3 | 0.3 | 0.3 | 0.3 | 0.3 | 0.3 | 0.3 |
| layer | layer | (T0) | | | | | | | | | | |
| | | E* of SIBS composition (MPa) | 3 | — | 3 | 3 | 3 | 3 | 1.5 | 2.2 | 4.5 | 5.5 |
| | | Styrene content of SIBS | 20 | — | 20 | 20 | 20 | 20 | 8 | 12 | 25 | 35 |
| | | (mass %) | | | | | | | | | | |
| | 2nd | Thickness of SIS or SIB layer | 0.15 | — | 0.15 | 0.15 | 0.15 | 0.15 | 0.15 | 0.15 | 0.15 | 0.15 |
| | layer | (mm) (T1) | | | | | | | | | | |
| | | E* of SIS or SIB composition | 3 | — | 1.5 | 2.2 | 4.5 | 5.5 | 3 | 3 | 3 | 3 |
| | | (MPa) | | | | | | | | | | |
| | | Styrene content of SIS or SIB | 20 | — | 8 | 12 | 25 | 35 | 10 | 16 | 16 | 16 |
| | | (mass %) | | | | | | | | | | |

| | | | | | | | | | | | |
|---|---|---|---|---|---|---|---|---|---|---|---|
| | Rate of change in thickness | 65 | 75 | 45 | 55 | 70 | 85 | 45 | 55 | 70 | 85 |
| | from time of drum-forming | | | | | | | | | | |
| | to time of extension (T1/T0 × 100) (%) | | | | | | | | | | |
| | Distance of lower end of | 100 | 100 | 100 | 100 | 100 | 100 | 100 | 100 | 100 | 100 |
| | air-seal layer from toe tip P (mm) | | | | | | | | | | |
| Performance | Variation in thickness of air-seal layer | 100 | 100 | 140 | 110 | 100 | torn | 140 | 110 | 100 | torn |
| assessment | Static air pressure drop rate | 100 | 100 | 100 | 100 | 100 | 100 | 100 | 100 | 100 | 100 |
| | Rolling resistance | 95 | 100 | 95 | 95 | 95 | 95 | 95 | 95 | 95 | 95 |

Note:
For the second layer, an elastomer composition including either SIS or SIB was used.

### Comparative Example 1

Comparative example 1 did not include the air-seal layer, and as an inner liner the following components were mixed in a Banbury mixer and formed in sheet by a calendering roll to provide a 1.0 mm thick polymer film.

IIR^{*1}: 90 parts by mass

Natural rubber^{*2}: 10 parts by mass

Filler^{*3}: 50 parts by mass

### ^{*1}IIR: Exxon Chlorobutyl 1068 by Exxon Mobil Corporation

### ^{*2}TSR20

^{*3}SEAST V by Tokai Carbon Co., Ltd. (N660, nitrogen adsorption specific surface area: 27m²/g)

### Examples 1-5 of Present Invention and Comparative Examples 2-5

The present invention in examples 1-5 provide an air-seal layer having a first layer of SIBS and a second layer of SIS or SIB. The first and second layers have dynamic moduli of elasticity (E^{*}) having different values. Comparative examples 2-5 provide the first or second layer with a dynamic modulus of elasticity (E^{*}) having a value that does not fall within the range of the present invention. The examples of the present invention all provide air-seal layers with limited variation in thickness, maintain an ability to seal air, and achieve improved rolling resistance.

<Performance Test>

The tires of the examples of the invention and those of the comparative examples for a truck or bus were produced as described above and underwent the following performance test.

<Variation in Thickness of Air-Seal Layer>

Each tire was measured at four locations on its circumference to obtain the air-seal layer's maximum and minimum values in thickness. A measured value of comparative example 1 served as a reference, and each example of the present invention and each comparative example underwent measurement to obtain values relative to the reference and the obtained values were indicated by indices. Smaller numerical values indicate smaller variation. If the air-seal layer is torn, it is indicated in Table 1 as “torn”.

<Static Air Pressure Drop Rate>

11R22.5PR truck or bus tires produced in the above described method were each assembled to a JIS rim and an initial air pressure of 900 Kpa was scaled therein, and the tires were then left at the room temperature for 90 days and thereafter the their static air pressure drop rates were measured. Values relative to that of comparative example 1 were indicated by indices. Smaller numerical values indicate smaller air pressure drops.

<Rolling Resistance>

A rolling resistance testing machine produced by Kobe Steel, Ltd. was used and a produced 11R22.5PR truck or bus tire was assembled to a JIS rim, and the tire's rolling resistance was measured for a load of 29.42 kN, an initial air pressure of 800 kPa and a speed of 80 km/hour, and room temperature (38° C.) as the tire travels. The following expression was employed with comparative example 1 serving as a reference (100) to indicate rolling resistance for each blending by an index. Smaller rolling resistance indices indicate reduced rolling resistance.

(rolling resistance index)=(rolling resistance of each example)/(rolling resistance of comparative example 1)×100

The present truck or bus tire is a concept including what is called tires for heavy vehicles and the like and is applicable to these tires.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A tire provided for a truck or bus and having an internal surface covered with an air-seal layer,
said air-seal layer having an end in a region within 120 mm as measured from a toe tip of a bead portion along a bead base line,
said air-seal layer being configured of a stack of layers of polymers including a first layer of an elastomer composition containing a styrene-isobutylene-styrene triblock copolymer and having a thickness of 0.05 mm to 0.6 mm and a second layer of an elastomer composition containing at least one of a styrene-isoprene-styrene triblock copolymer and a styrene-isobutylene diblock copolymer, having a thickness of 0.01 mm to 0.3 mm, and positioned adjacent to a carcass ply,
said first and second layers having said elastomer compositions with a dynamic modulus of elasticity (E^{*}) having a value equal to or larger than 2 MPa and equal to or smaller than 5 MPa.

2. The tire provided for a truck or bus according to claim 1, wherein said stack of layers of polymers has a first thickness (T0) when formed on a drum in forming the tire, whereas said stack of layers of polymers has a second thickness (T1) when extended in a toroid, with a ratio of said second thickness (T1) to said first thickness (T0)(T1/T0×100) being 50-75% between a buttress portion of the tire and an equatorial plane of the tire.

3. The tire provided for a truck or bus according to claim 1, wherein said styrene-isobutylene-styrene triblock copolymer contains styrene units in a content of 10-30% by mass.

4. The tire provided for a truck or bus according to claim 1, wherein said styrene-isoprene-styrene triblock copolymer contains styrene units in a content of 10-30% by mass and has a weight average molecular weight of 100,000 to 290,000.

5. The tire provided for a truck or bus according to claim 1, wherein said styrene-isobutylene diblock copolymer is of a straight chain, contains styrene units in a content of 10-35% by mass, and has a weight average molecular weight of 40,000 to 120,000.
